(19) United States
(12) Patent Application Publication
(10) Pub. No.: US 2013/0335347 A1
(43) Pub. Date: Dec. 19, 2013

(54) TOUCH DISPLAY DEVICES, COVER LENS THEREOF AND BONDING EQUIPMENT FOR FABRICATING TOUCH DISPLAY DEVICE

(71) Applicant: HANNSTAR DISPLAY CORP., New Taipei City (TW)

(72) Inventors: Kun Lung WU, New Taipei City (TW); Ke-Chin CHANG, New Taipei City (TW); Chia-Feng TENG, New Taipei City (TW)

(73) Assignee: Hannstar Display Corp., New Taipei City (TW)

(21) Appl. No.: 13/738,723

(22) Filed: Jan. 10, 2013

(30) Foreign Application Priority Data
Jun. 14, 2012 (TW) 201210196476.8

(51) Int. Cl. G06F 3/041

(52) U.S. Cl. CPC G06F 3/041
USPC 345/173; 156/556

(57) ABSTRACT

A touch display device is provided. The touch display device includes a cover lens which has a first flat outside surface and an opposite second concave inner surface. A touch sensing element is disposed under the second surface of the cover lens and a display element is disposed under the touch sensing element. A border adhesive is disposed between the display element and the touch sensing element to form a gap surrounded by the border adhesive. A height at the center of the gap is higher than a height at the periphery of the gap. Further, a bonding equipment for fabricating the touch display device is provided. The bonding equipment includes a first and a second tray component for carrying the cover lens and the touch sensing element, respectively.

### CROSS REFERENCE TO RELATED APPLICATIONS

This Application claims priority of the People's Republic of China Patent Application No. 201210196476.8, filed on Jun. 14, 2012, the entirety of which is incorporated by reference herein.

### BACKGROUND OF THE INVENTION

1. Field of the Invention

The present invention relates to a touch display device, and in particular, a touch display device using a border adhesive to bond an upper component and a lower component together.

2. Description of the Related Art

Currently, major components of a touch display device, such as a cover lens, a touch sensing element layer and a display panel are sheet structures. The touch sensing element layer adhered to the cover lens is bonded with the display panel by a border adhesive. A gap surrounded by the border adhesive is formed between the display panel and the touch sensing element layer.

For thinner touch display devices, the thickness of the border adhesive must also be thinner. Accordingly, the gap surrounded by the border adhesive formed between the display panel and the touch sensing element layer is reduced. Because the sheet components of the touch display device such as the cover lens, the touch sensing element layer and the display panel are processed by high-temperature processes, due to the process, an inherent stress of each sheet component of the touch display device is released to cause warped in each sheet component. While the gap between the component located above the border adhesive and the component located under the border adhesive is reduced with the thinner touch display device, it makes the upper component contact with the lower component, thereby causing the Newton's ring phenomenon found with conventional thin touch display devices. The Newton's ring phenomenon decreases display quality of a conventional thin touch display device.

Therefore, mitigating the above problems through further development of thin touch display devices is needed.

### BRIEF SUMMARY OF THE INVENTION

Therefore, the embodiments of the invention provide touch display devices which use a design structure of a cover lens or a touch sensing element to make a gap between an upper component and a lower component of the touch display devices have a height at a center of the gap higher than a height at a periphery of the gap. This prevents the upper component from contacting the lower component of the touch display devices. Therefore, the Newton's ring phenomenon found with the conventional thin touch display device does not occur.

According to an illustrative embodiment, a touch display device is provided. The touch display device comprises a cover lens having a first surface and a second surface opposite to the first surface, wherein the first surface is a flat surface. A touch sensing element is disposed under the second surface of the cover lens. A display element is disposed under the touch sensing element. Furthermore, a border adhesive is disposed between the touch sensing element and the display element to form a gap surrounded by the border adhesive. The gap is formed between the touch sensing element and the display element, wherein a height at a center of the gap is higher than a height at a periphery of the gap, and the periphery of the gap is adjacent to the border adhesive.

According to an illustrative embodiment, a cover lens of a touch display device is provided. The cover lens comprises a glass substrate having a first surface located at a touch side and a second surface opposite to the first surface, wherein the first surface is a flat surface and the second surface is a concave surface.

According to an illustrative embodiment, a bonding equipment for fabricating a touch display device is provided. The bonding equipment comprises a first tray component having a recess portion for carrying a cover lens and a second tray component having a recess portion for carrying a touch sensing element, wherein the recess portion of the second tray component is disposed opposite to the recess portion of the first tray component, and a bottom surface of the recess portion of the second tray component is a circular-arc type convex surface.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows an illustrative cross section of a touch display device according to an embodiment of the invention;

FIG. 2 shows an illustrative cross section of a touch display device according to an embodiment of the invention;

FIG. 3 shows an illustrative cross section of a touch display device according to an embodiment of the invention;

FIG. 4 shows an illustrative cross section of a touch display device according to an embodiment of the invention; and

FIGS. 5A and 5B show illustrative cross sections of a process for bonding a cover lens with a touch sensing element of a touch display device by a bonding equipment according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

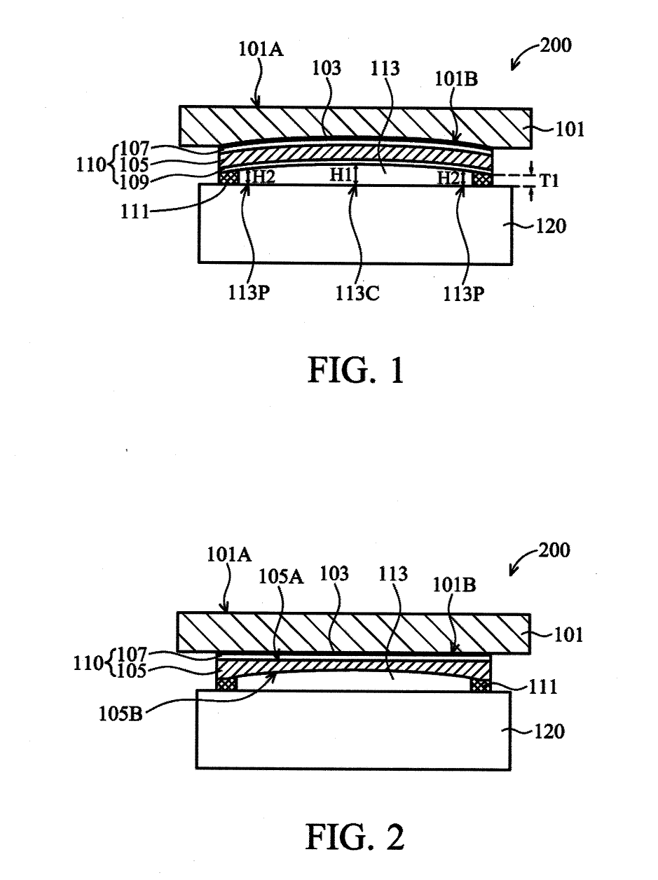

Referring to FIG. 1, a cross section of a touch display device 200 according to an embodiment of the invention is shown. The touch display device 200 includes a cover lens 101. The cover lens 101, for example a tempered/strengthened glass, has a first surface 101A (outside surface) used as a touch side, and a second surface 101B (inside surface) opposite to the first surface 101A. In the embodiment, the first surface 101A is a flat surface and the second surface 101B is a concave surface. The concave surface of the second surface 101B can be formed by a polishing process or an etching process. The concave surface of the second surface 101B may be a circular-arc type concave surface or a trapezoid concave surface. In this embodiment, the concave surface of the second surface 101B is a circular-arc type concave surface, which consists of a plurality of inclined planes with gradually changed gradients. In another way, a trapezoid concave surface consists of two side inclined planes and one middle flat plane.

A touch sensing element 110 is disposed under the second surface 101B of the cover lens 101. The touch sensing element 110 can be bonded with the cover lens 101 by using an adhesive 103. The material of the adhesive 103 is for example a hydrogel. The touch sensing element 110 is conformally adhered to the second surface 101B of the cover lens 101, under the concave surface. In the embodiment, the touch sensing element 110 includes a substrate 105 and two touch sensing layers 107 and 109 formed on an outside and an inside surface of the substrate 105, respectively. The substrate 105 may be a glass substrate or a plastic film. The touch sensing layers 107 and 109 individually include a plurality of touch sensing electrodes which can be formed of transparent conductive materials. In addition, the touch sensing electrodes can be formed of any patterns which are dependent on design requirements for the touch sensing electrodes. Through the touch sensing electrodes of the touch sensing layers 107 and 109, an orientation at an X-axis direction and a Y-axis direction in the positions of the touch display device 200 touched by a user is provided.

In another embodiment, the touch sensing element 110 of FIG. 1 can also have only one of the touch sensing layers 107 and 109 formed on one side of the substrate 105. Through the touch sensing electrodes of the touch sensing layers 107 or 109, an orientation at both an X-axis direction and a Y-axis direction about the positions of the touch display device 200 touched by a user can be simultaneously provided.

Furthermore, the touch display device 200 includes a display element 120 disposed under the touch sensing element 110. The display element 120 is for example a liquid crystal display panel or other kinds of display panels. The display element 120 is bonded with the touch sensing element 110 by a border adhesive 111. An air gap 113 is formed between the display element 120 and the touch sensing element 110, surrounded by the border adhesive 111. The border adhesive 111 is for example a twin adhesive. In an embodiment, the border adhesive 111 has a thickness T1 of about 0.3 mm or less than 0.3 mm.

In the embodiment, because the second surface 101B of the cover lens 101 has a concave surface and the touch sensing element 110 is conformally adhered under the concave surface, at a center 113C of the air gap 113 between the display element 120 and the touch sensing element 110 has a height H1 greater than a height H2 at a periphery 113P of the air gap 113, wherein the periphery 113P is adjacent to the border adhesive 111. According to the embodiments of the invention, the height H1 is higher than that of the height H2 by at least 0.2 mm, for example, the height H1 may be higher than that of the height H2 by 0.2 mm to 5 mm. According to the embodiments of the invention, even if the air gap 113 is decreased by reducing the thickness T1 of the border adhesive 111, a component disposed above the border adhesive 111, such as the touch sensing element 110, is still prevented from contacting with a component disposed under the border adhesive 111, such as the display element 120. Therefore, there is no Newton ring phenomenon produced in the touch display device 200.

Referring to FIG. 2, a cross section of a touch display device 200 according to another embodiment of the invention is shown. The touch display device 200 includes a cover lens 101. The cover lens 101 has a first surface 101A used as a touch side and a second surface 101B for bonding to a touch sensing element 110. In the embodiment, both the first surface 101A and the second surface 101B are flat surfaces, but a substrate of the touch sensing element 110 has a flat third surface 105A and a concave fourth surface 105B. The third surface 105A can be provided for forming a touch sensing layer 107 thereon and the fourth surface 105B can be disposed to face a display element 120 and bond to the display element 120 by a border adhesive 111. As a result, an air gap 113 is formed between the substrate 105 of the touch sensing element 110 and the display element 120. In the embodiment, the substrate 105 may be a glass substrate, thus, a concave shape of the fourth surface 105B of the substrate 105 can be formed by a polishing process or an etching process. The concave shape of the fourth surface 105B may be a circular-arc type concave surface or a trapezoid concave surface. In this embodiment, the concave shape of the fourth surface 105B is a circular-arc type concave surface, which consists of a plurality of inclined planes with gradually changing gradients. In another embodiment, the concave shape of the fourth surface 105B is a trapezoid concave surface consisting of two side inclined planes and one middle flat plane

In the embodiment, because the lower side of the substrate 105 of the touch sensing element 110 is the fourth surface 105B of a concave shape, at a center of the air gap 113 between the display element 120 and the substrate 105 of the touch sensing element 110, there is a height greater than a height at a periphery of the air gap 113. According to the embodiments of the invention, the height at the center of the air gap 113 is higher than that of the height at the periphery of the air gap 113 by 0.2 mm to 5 mm. As a result, this can effectively prevent the substrate 105 of the touch sensing element 110 from contacting the display element 120. Therefore, there is no Newton ring phenomenon produced in the touch display device 200.

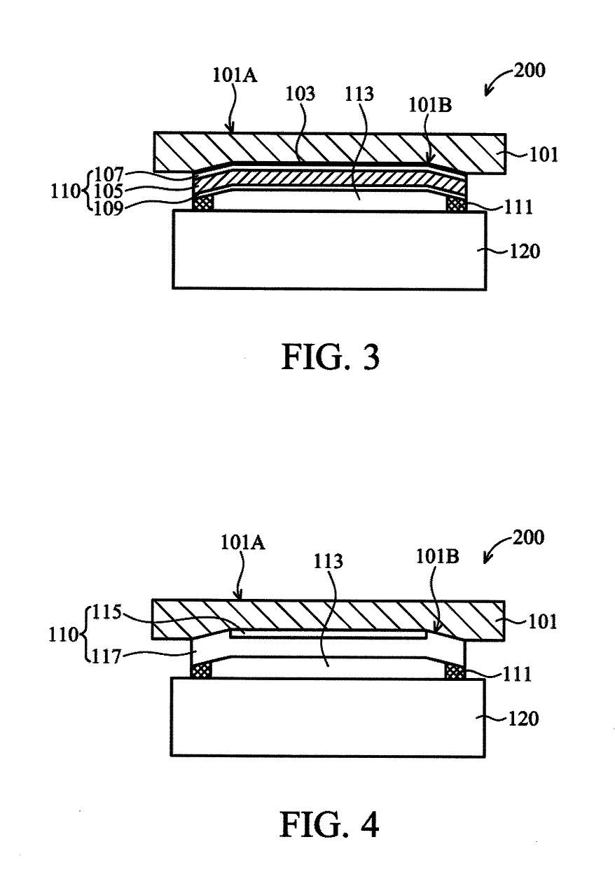

Referring to FIG. 3, a cross section of a touch display device 200 according to another embodiment of the invention is shown. The difference between the touch display devices 200 of FIG. 3 and FIG. 1 is that a second surface 101B of a cover lens 101 of FIG. 3 is a trapezoid concave surface. The trapezoid concave surface can be formed by a polishing process or an etching process.

In the embodiment of FIG. 3, an air gap 113, surrounded by a border adhesive 111, formed between the display element 120 and the touch sensing element 110 also has a characteristic of having a height at a center of the air gap 113 being greater than a height at a periphery of the air gap 113. Furthermore, the height at the center of the air gap 113 is higher than that of the height at the periphery of the air gap 113 by at least 0.2 mm to 5 mm. As a result, this can effectively prevent the touch sensing element 110 from contacting the display element 120. Therefore, there is no Newton ring phenomenon produced in the touch display device 200.

In another embodiment, the touch sensing element 110 of FIG. 3 may have only one of the touch sensing layers 107 and 109 formed on one side of the substrate 105. Through the touch sensing electrodes of the touch sensing layers 107 or 109, an orientation at both an X-axis direction and a Y-axis direction about the positions of the touch display device 200 touched by a user can be simultaneously provided.

Referring to FIG. 4, a cross section of a touch display device 200 according to another embodiment of the invention is shown. In the embodiment, a touch sensing element 110 does not include a normal substrate. The touch sensing element 110 is formed by directly forming a touch sensing layer 115 on a concave second surface 101B of a cover lens 101. Furthermore, a protection layer 117 is formed on the second surface 101B of the cover lens 101 to cover the touch sensing layer 115. The material of the protection layer 117 may be an organic or an inorganic insulating material. The touch sensing layer 115 combines with the protection layer 117 to form the touch sensing element 110. Then, the protection layer 117 of the touch sensing element 110 is bonded to a display element 120 by a border adhesive 111. An air gap 113 is formed between the protection layer 117 and the display element 120.

In the embodiment, because the protection layer 117 is conformally formed on the concave second surface 101B of the cover lens 101, the protection layer 117 has the same concave shape as that of the concave second surface 101B. As a result, the air gap 113 produced between the protection layer 117 and the display element 120 has a height at a center of the air gap 113 which is higher than a height at a periphery of the air gap 113. The height at the center of the air gap 113 is higher than that of the height at the periphery of the air gap 113 by at least 0.2 mm to 5 mm. Thus, this can effectively prevent the touch sensing element 110 from contacting with the display element 120. Therefore, there is no Newton ring phenomenon produced in the touch display device 200.

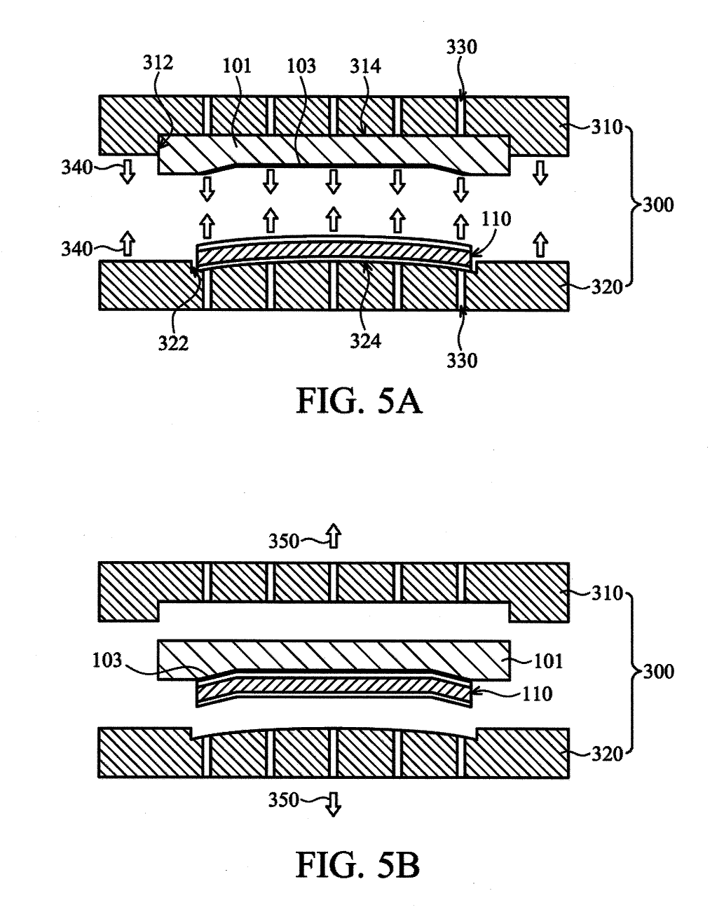

Referring to FIG. 5A and FIG. 5B, cross sections of a process for bonding a cover lens 101 to a touch sensing element 110 of a touch display device 200 by a bonding equipment 300 according to an embodiment of the invention are shown. The cover lens 101 and the touch sensing element 110 of the touch display device 200 of FIG. 3 is used as an example to illustrate an embodiment. However, the cover lens 101 and the touch sensing element 110 of the touch display devices 200 of the other embodiments as mentioned above can also be formed by using the bonding equipment 300 to perform a bonding process.

The bonding equipment 300 includes a first tray component 310, which has a recess portion 312 for carrying a cover lens 101. A bottom surface 314 of the recess portion 312 may be a flat surface. The bottom surface 314 is in contact with a first surface 101A of the cover lens 101. The bonding equipment 300 further includes a second tray component 320, which has a recess portion 322 for carrying a touch sensing element 110. The recess portion 322 of the second tray component 320 is disposed to face the recess portion 312 of the first tray component 310. Moreover, a bottom surface 324 of the recess portion 322 of the second tray component 320 may have a circular-arc type convex surface. The circular-arc type convex surface can help the touch sensing element 110 for conformally adhering to a second surface 101B of the cover lens 101, under a concave surface of the second surface 101B.

As shown in FIG. 5A, the first tray component 310 and the second tray component 320 respectively have a plurality of vacuum holes 330. The vacuum holes 330 are connected to the recess portion 312 of the first tray component 310 and the recess portion 322 of the second tray component 320, respectively, and further connected to a vacuum device (not shown). When the vacuum device is on, the cover lens 101 and the touch sensing element 110 are sucked and adhered onto the first tray component 310 and the second tray component 320, respectively, through the vacuum holes 330. Next, the first tray component 310 and the second tray component 320 are closed with each other, as shown in the arrow 340 of FIG. 5A, to perform the bonding process of the cover lens 101 and the touch sensing element 110. In an embodiment, an adhesive 103 may be coated on a surface of the cover lens 101 or a surface of the touch sensing element 110 to help with the bonding of the cover lens 101 and the touch sensing element 110.

After the bonding process of the cover lens 101 and the touch sensing element 110 is completed, the vacuum device is turned off to make the first tray component 310 and the second tray component 320 separate from each other, as shown in the arrow 350 of FIG. 5B, to complete a bonded structure of the cover lens 101 and the touch sensing element 110. Then, the bonded structure of the cover lens 101 and the touch sensing element 110 is bonded to a display element 120 by a border adhesive 111 to complete the fabrication of the touch display device 200.

According to the embodiments of the invention, the first surface 101A (outside surface) of the cover lens 101 of the touch display device 200 used as a touch side is kept in a flat state and the display element 120 is also kept in a sheet structure without bends and warped. From an overall view of the touch display device 200, the touch display device 200 has a structure without bends and warped. Through the design of the second surface 101B (inside surface) of the cover lens 101 having a concave shape surface and the touch sensing element 110 being conformally adhered under the concave shape surface, the air gap 113, surrounded by the border adhesive 111, between the display element 120 and the touch sensing element 110 has a characteristic of having a height at a center of the air gap 113 which is higher than a height at a periphery of the air gap 113. In another way, when the second surface 101B of the cover lens 101 is kept in a flat state, through the design of the fourth surface 105B (inside surface) of the substrate 105 of the touch sensing element 110 having a concave shape surface, the air gap 113, surrounded by the border adhesive 111, between the display element 120 and the touch sensing element 110 also has the characteristic of a having a height at a center of the air gap 113 which is higher than a height at a periphery of the air gap 113. Thus, the embodiments of the invention can effectively prevent the component disposed above the border adhesive 111 from contacting with the component disposed under the border adhesive 111. Accordingly, there is no Newton ring phenomenon produced in the touch display devices 200. Furthermore, the quality of displaying images of the touch display devices 200 is also enhanced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch display device, comprising:
a cover lens, having a first surface and a second surface opposite to the first surface;
a touch sensing element disposed under the second surface of the cover lens;
a display element disposed under the touch sensing element; and
a border adhesive disposed between the touch sensing element and the display element to form a gap surrounded by the border adhesive, wherein a height at a center of the gap is higher than a height at a periphery of the gap.

2. The touch display device of claim 1, wherein the second surface of the cover lens is a flat surface.

3. The touch display device of claim 1, wherein the second surface of the cover lens is a concave surface.

4. The touch display device of claim 3, wherein the concave surface of the second surface is a circular-arc type concave surface or a trapezoid concave surface.

5. The touch display device of claim 1, wherein the touch sensing element includes a touch sensing layer and a protection layer both formed on the second surface of the cover lens.

6. The touch display device of claim 1, wherein the touch sensing element includes a substrate having a third surface and a fourth surface opposite to the third surface.

7. The touch display device of claim 6, wherein the fourth surface is disposed to face the display element.

8. The touch display device of claim 6, wherein the fourth surface of the substrate is a concave surface.

9. The touch display device of claim 8, wherein the concave surface of the fourth surface is a circular-arc type concave surface or a trapezoid concave surface.

10. The touch display device of claim 6, wherein the touch sensing element includes a touch sensing layer formed on the third surface of the substrate.

11. The touch display device of claim 6, wherein the touch sensing element includes a touch sensing layer formed on the fourth surface of the substrate.

12. The touch display device of claim 1, wherein the border adhesive has a thickness of less than or equal to 0.3 mm.

13. The touch display device of claim 1, wherein the height at the center of the gap is higher than that of the height at the periphery of the gap by at least 0.2 mm.

14. The touch display device of claim 1, wherein the height at the center of the gap is higher than that of the height at the periphery of the gap by 0.2 mm to 5 mm.

15. A cover lens of a touch display device, having a flat surface and a concave surface, wherein the concave surface is a circular-arc type concave surface or a trapezoid concave surface.

16. A touch sensing element, comprising:
a substrate having a third surface and a fourth surface opposite to the third surface, wherein the fourth surface of the substrate is a concave surface; and
at least one touch sensing layer formed on at least one of the third surface and the fourth surface of the substrate.

17. The touch sensing element of claim 16, wherein the concave surface of the fourth surface is a circular-arc type concave surface or a trapezoid concave surface.

18. A bonding equipment for fabricating a touch display device, comprising:
a first tray component, having a recess portion for carrying a cover lens; and
a second tray component, having a recess portion for carrying a touch sensing element,
wherein the recess portion of the second tray component is disposed opposite to the recess portion of the first tray component, and a bottom surface of the recess portion of the second tray component is a circular-arc type convex surface.
